(19) United States
(12) Patent Application Publication
(10) Pub. No.: US 2026/0287369 A1
(43) Pub. Date: Sep. 24, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventor: Takao Tamura, Tokyo (JP)

(21) Appl. No.: 19/542,694

(22) Filed: Feb. 18, 2026

(30) Foreign Application Priority Data
Mar. 19, 2025 (JP) 2025-045821

(51) Int. Cl. G01C 21/34; B60W 30/18; B60W 60/00

(52) U.S. Cl. CPC G01C 21/3415; B60W 30/18159; B60W 60/0011; G01C 21/3461; B60W 2540/18; B60W 2552/00

(57) ABSTRACT

A travel control device calculates a second route calculated in a case where a destination is not set; when the vehicle proceeds to a point at which a plurality of route candidates exist, calculates the second route such that the vehicle proceeds to a first road determined based on a predetermined priority order among the plurality of route candidates; and in a case where an angle of the first road with respect to a road on which the vehicle travels when the vehicle enters the point is equal to or less than a predetermined angle, or in a case where a steering control amount becomes equal to or greater than a predetermined value in a case where the vehicle proceeds to the first road, calculates the second route such that the vehicle proceeds to a second road having a lower priority order than the first road.

### CROSS-REFERENCE TO RELATED APPLICATION

Priority is claimed on Japanese Patent Application No. 2025-045821, filed Mar. 19, 2025, the content of which is incorporated herein by reference.

### BACKGROUND

### Field of Invention

The present invention relates to a travel control device, a travel control method, and a storage medium.

### Description of Related Art

In recent years, there have been increasing attempts to provide access to a sustainable transportation system that takes into consideration the most vulnerable traffic participants. For this realization, research and development efforts are focused on further improving the safety and convenience of transportation through research and development related to automated driving technology.

In relation to this, conventionally, in a driving assistance device that determines an automated driving mode based on whether or not a destination is set by a driver and performs travel control of a vehicle based on the determined automated driving mode, a technique is known in which, in a case where a destination is not set, travel control is performed by following-the-road travel (see, for example, Japanese Patent No. 5382218). For example, Japanese Patent No. 5382218 discloses, as an example of following-the-road travel, determining a route of a vehicle based on road width and the like.

### SUMMARY

In conventional automated driving technologies, there may be a case where an intersection angle between a road having a wide road width selected as a traveling destination of a vehicle and a road on which the vehicle is currently traveling is small, and, when attempting to guide the vehicle to the road having the wide road width, travel control may become difficult depending on the intersection angle. As described above, in conventional automated driving technologies, there has been a problem in that travel control is not necessarily performed smoothly.

One of the objects of the present application is to provide a travel control device, a travel control method, and a storage medium that can smoothly execute travel control even in a case where a road having a small intersection angle exists. Further, the present application contributes to the development of a sustainable transportation system.

A travel control device of a first aspect of the present invention includes a storage medium storing computer-readable instructions; and one or more processors connected to the storage medium, the processor executing the computer-readable instructions to: calculate, in calculating a route along which a vehicle travels, a first route calculated in a case where a destination is set, or a second route calculated in a case where a destination is not set, perform travel control of the vehicle along the calculated first route or the calculated second route calculated, when the vehicle proceeds to a point at which a plurality of route candidates exist, calculate the second route such that the vehicle proceeds to a first road determined based on a predetermined priority order among the plurality of route candidates, and in a case where an angle of the first road with respect to a road on which the vehicle travels when the vehicle enters the point is equal to or less than a predetermined angle, or in a case where a steering control amount

becomes equal to or greater than a predetermined value in a case where the vehicle proceeds to the first road, calculate the second route such that the vehicle proceeds to a second road having a lower priority order than the first road.

A second aspect is the travel control device according to the first aspect, in which the one or more processors may execute the computer-readable instructions to: in a case where a plurality of the second roads exist among the plurality of route candidates, select the second road closest to straight travel among the plurality of second roads.

A third aspect is the travel control device according to the first aspect, in which the one or more processors may execute the computer-readable instructions to: in a case where the second road does not exist among the plurality of route candidates, or in a case where it is determined that it is difficult for the vehicle to proceed to the second road, calculate a different second route at an intersection or a branch point before the vehicle reaches the point.

A fourth aspect is the travel control device according to the first aspect, in which the priority order is based on a road width.

A travel control method according to a fifth aspect of the present invention is a travel control method executed by a computer, the travel control method including calculating, in calculating a route along which a vehicle travels, a first route calculated in a case where a destination is set, or a second route calculated in a case where a destination is not set, performing travel control of the vehicle along the calculated first route or the calculated second route, when the vehicle proceeds to a point at which a plurality of route candidates exist, calculating the second route such that the vehicle proceeds to a first road determined based on a predetermined priority order among the plurality of route candidates, and in a case where an angle of the first road with respect to a road on which the vehicle travels when the vehicle enters the point is equal to or less

than a predetermined angle, or in a case where a steering control amount becomes equal to or greater than a predetermined value in a case where the vehicle proceeds to the first road, calculating the second route such that the vehicle proceeds to a second road having a lower priority order than the first road.

A sixth aspect of the present invention is a computer-readable non-transitory storage medium storing a program, the program causing a computer to calculate, in calculating a route along which a vehicle travels, a first route calculated in a case where a destination is set, or a second route calculated in a case where a destination is not set, perform travel control of the vehicle along the calculated first route or the calculated second route, when the vehicle proceeds to a point at which a plurality of route candidates exist, calculate the second route such that the vehicle proceeds to a first road determined based on a predetermined priority order among the plurality of route candidates, and in a case where an angle of the first road with respect to a road on which the vehicle travels when the vehicle enters the point is equal to or less than a predetermined angle, or in a case where a steering control amount becomes equal to or greater than a predetermined value in a case where the vehicle proceeds to the first road, calculate the second route such that the vehicle proceeds to a second road having a lower priority order than the first road.

According to the first to sixth aspects described above, smooth travel control can be executed even in a case where a road having a small intersection angle exists.

### BRIEF DESCRIPTION OF THE DRAWINGS

FIG. 1 is a configuration diagram of a vehicle system including a travel control device according to an embodiment.

FIG. 2 is a functional configuration diagram of a first control unit and a second control unit according to the embodiment.

FIG. 3 is a diagram for explaining an example of calculation of a first route and generation of a target trajectory.

FIG. 4 is a diagram for explaining an example of calculation of a second route and generation of a target trajectory.

FIG. 5 is a diagram illustrating an example of first information.

FIG. 6 is a diagram illustrating an example of second information.

FIG. 7 is a diagram illustrating an example of a road shape of a T-shaped intersection.

FIG. 8 is a diagram illustrating an example of a road shape of a roundabout.

FIG. 9 is a diagram illustrating an example of following-the-road travel in a situation where a destination is not set.

FIG. 10 is a diagram illustrating an example of following-the-road travel in a situation where a destination is not set.

FIG. 11 is a diagram for illustrating an example of a case where a second road having a lower priority order than a first road is selected.

FIG. 12 is a flowchart illustrating an example of a flow of processing executed by an automated driving control device.

### DESCRIPTION OF EMBODIMENTS

Hereinafter, embodiments of a travel control device, a travel control method, and a storage medium of the present invention will be described with reference to the drawings. Hereinafter, as an example, an embodiment in which the travel control device is applied to an automated driving vehicle will be described. Automated driving means, for example, executing driving control by automatically controlling one or both of steering and speed of a vehicle. Examples of the above-described driving control may include driving control such as an Adaptive Cruise Control System (ACC), Traffic Jam Pilot (TJP), Lane Keeping Assistance System (LKAS), Automated Lane Change (ALC), and Collision Mitigation Brake System (CMBS). Further, in the automated driving vehicle, driving control according to a manual operation (so-called manual driving) of a user (for example, an occupant) of the vehicle may be executed. Further, hereinafter, a case where regulations for left-side traffic are applied will be described; however, in a case where regulations for right-side traffic are applied, left and right may be read oppositely.

### Overall Configuration

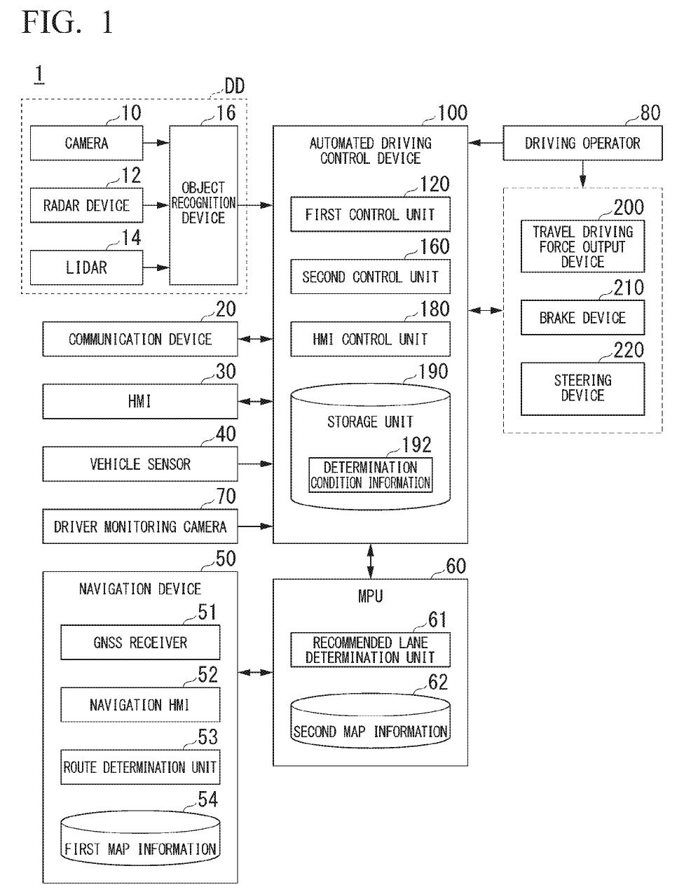

FIG. 1 is a configuration diagram of a vehicle system 1 including a travel control device according to an embodiment. A vehicle (hereinafter referred to as a vehicle M) in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generation unit connected to the internal combustion engine or electric power that is supplied when a secondary battery (power storage) or a fuel cell is discharged.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices and equipment are connected to each other by multiple communication lines, such as a control unit area network (CAN) communication line, serial communication lines, wireless communication networks, or the like. Further, the configuration shown in FIG. 1 is merely an example, and some of the configuration may be omitted, or other configuration may be added. The camera 10 is an example of an “imaging unit”. A combination of the camera 10, the radar device 12, the LIDAR 14, and the object recognition device 16 is an example of a “detection device DD”. The HMI 30 is an example of a “reception unit” or an “output unit”. The automated driving control device 100 is an example of a “travel control device”.

For example, the camera 10 is a digital camera using a solid-state imaging element such as, for example, a charge-coupled device (CCD) or a complementary metal oxide semiconductor (CMOS). The camera 10 is attached to any location on the vehicle M in which the vehicle system 1 is mounted. For example, when the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the side of the vehicle M are imaged, the camera 10 is attached to a door mirror, or the like. The camera 10 captures images of the surroundings of the vehicle M repeatedly, for example, periodically. The camera 10 may also be a stereo camera.

The radar device 12 emits radio waves such as millimeter waves to the surroundings of the vehicle M, and detects electromagnetic waves (reflected waves) reflected by surrounding objects to detect at least positions (distances and orientations) of the objects. The radar device 12 is attached to the vehicle M at an arbitrary location. The radar device 12 may detect the position and speed of the object using a frequency modulated continuous wave (FM-CW) method.

The LIDAR 14 radiates light to the vicinity of the vehicle M and measures scattered light. The LIDAR 14 detects the distance to the subject on the basis of the time between light emission and reception. The emitted light is, for example, a pulsed laser beam. The LIDAR 14 is attached to an arbitrary position of the vehicle M.

The object recognition device 16 executes sensor fusion processing on some or all of the detection results from the camera 10, the radar device 12, and the LIDAR 14 to recognize the position, type, speed, etc. of the object. The object recognition device 16 outputs the recognition results to the automated driving control device 100. In addition, the object recognition device 16 may output the detection results of the camera 10, the radar device 12, and the LIDAR 14 to the automated driving control device 100 as they are. In this case, the object recognition device 16 may be omitted from a configuration of the vehicle system 1 (the detection device DD).

The communication device 20 communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to the occupant of the vehicle M and receives input operations by the occupant. The HMI 30 includes, for example, various display devices, speakers, buzzers, touch panels, switches, keys, and microphones. Examples of the display device include a liquid crystal display (LCD) device and an organic electroluminescence (EL) display device. The display device is provided in the vicinity of the front of a driver’s seat (a seat closest to the steering wheel) on an instrument panel and is installed at a position which can be seen by an occupant through a gap of the steering wheel or over the steering wheel. In addition, the display device may be installed in a center of the instrument panel. In addition, the display device may also be a head up display (HUD). The HUD allows an occupant sitting on the driver’s seat to see a virtual image by projecting an image to a part of a front windshield in front of the driver’s seat. The display device displays an image which is generated by the HMI control unit 180 which will be described later. Moreover, the HMI 30 may include a driving changeover switch or the like for switching between automated driving and manual driving by the occupant.

The vehicle sensor 40 includes a vehicle speed sensor configured to detect the speed of the vehicle M, an acceleration sensor configured to detect acceleration, a yaw rate sensor configured to detect a yaw rate (for example, a rotational angular velocity around a vertical axis passing through the center of gravity of the vehicle M), a direction sensor configured to detect the direction of the vehicle M, and the like. In addition, the vehicle sensor 40 may be provided with a position sensor that detects the position of the vehicle. The position sensor is, for example, a sensor that acquires position information (longitude and latitude information) from a global positioning system (GPS) device. Further, the position sensor may be a sensor that acquires position information using a global navigation satellite system (GNSS) receiver 51 of the navigation device 50. The vehicle sensor 40 may derive the speed of the vehicle M from a difference (that is, a distance) in positional information at a predetermined time in the position sensor. A detection result of the vehicle sensor 40 is output to the automated driving control device 100.

The navigation device 50 includes, for example, a GNSS receiver 51, a navigation HMI 52, and a route determination unit 53. In the navigation device 50, first map information 54 is retained in a storage device such as a hard disk drive (HDD) or a flash memory. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The GNSS receiver 51 may be provided in the vehicle sensor 40. The navigation HMI 52 may be partially or completely shared with the HMI 30 described above. The route determination unit 53 determines, for example, a route (hereinafter, a route on map) to a destination input by an occupant using the navigation HMI 52 from a position of the vehicle M (or an arbitrary position that was input) specified by the GNSS receiver 51 with reference to the first map information 54. The first map information 54 is, for example, information that represents a shape of a road using links that indicate roads and nodes connected by the links. The first map information 54 may include point of interest (POI) information, and the like. The route on map is output to the MPU 60. The navigation device 50 may perform route guidance using the navigation HMI 52 on the basis of the route on map. The navigation device 50 may transmit the current position and destination to a navigation server via the communication device 20, and acquire the same route as the route on map from the navigation server. The navigation device 50 outputs a determined route on the map to the MPU 60.

The MPU 60 includes, for example, a recommended lane determination unit 61 and stores second map information 62 in a storage device such as an HDD or a flash memory. The recommended lane determination unit 61 divides the route on the map provided from the navigation device 50 into a plurality of blocks (for example, divides the route every 100 [m] in a traveling direction of the vehicle), and determines a recommended lane for each block with reference to the second map information 62. The recommended lane determination unit 61 determines which lane from the left the vehicle travels on. The recommended lane determination unit 61 determines the recommended lane so that the vehicle M can travel along a reasonable route for traveling to a branching destination when there is a branch point in the route on the map.

The second map information 62 is map information more accurate than the first map information 54. The second map information 62 includes, for example, road types, the number of lanes, road widths, types and shapes of road lane markings (hereinafter referred to as lane markings), information on centers of lanes, or information on road boundaries. In addition, the second map information 62 may include road shape information, traffic regulation information, address information (address and zip code), facility information, parking lot information, telephone number information, and the like. Road shape information includes, for example, types of intersections (such as a crossroads, T-shaped intersections, Y-shaped intersections, roundabouts, and the like), branching, merging, lane increase/decrease points, road curvature (which may be replaced with a radius of curvature; the same applies hereinafter), an amount of change in curvature for each predetermined distance, road width, gradient, and the like.

In addition, the second map information 62 may include information related to a line indicating a center of a lane (center line). The center line is a center line between left and right lane markings. The center line may exist in a lane in which either one of the left and right lane markings that define the lane is interrupted.

The second map information 62 may be updated at any time by the communication device 20 communicating with an external device. The first map information 54 and the second map information 62 may be integrally provided as map information. Further, the map information may be stored in a storage unit 190.

The driver monitoring camera 70 is, for example, a digital camera that uses a solid-state imaging element such as a CCD or a CMOS. The driver monitoring camera 70 is attached to an arbitrary position on the vehicle M in a place and a direction in which the head of an occupant (a driver) sitting on a driver’s seat of the vehicle M can be imaged from the front (such that the face of the driver is imaged). For example, the driver monitoring camera 70 is attached to an upper part of a display device which is provided at the center of the instrument panel of the vehicle M.

The driving operator 80 includes, for example, a steering wheel, an accelerator pedal, and a brake pedal. In addition, the driving operator 80 may include a shift lever, a modified steering wheel, a joystick, or other operators. An operation detector that detects an amount of operation with respect to the operator by the occupant or presence or absence of the operation, for example, is attached to each operator of the driving operator 80. The operation detector detects, for example, a steering angle or steering torque of the steering wheel, and an amount of depression of the accelerator pedal or the brake pedal. The operation detector outputs detection result to one or both of the automated driving control device 100, and the travel driving force output device 200, the brake device 210 and the steering device 220.

The automated driving control device 100 executes various operation controls belonging to automated driving for the vehicle M. The automated driving control device 100 includes, for example, a first control unit 120, a second control unit 160, an HMI control unit 180, and a storage unit 190. The first control unit 120, the second control unit 160, and the HMI control unit 180 are realized, for example, by causing a hardware processor such as a central processing unit (CPU) to execute a program (software). Further, some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by a combination of software and hardware. The program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like. The HMI control unit 180 is an example of an “output control unit”.

The storage unit 190 may be implemented by the above-described various storage devices an electrically erasable programmable read-only memory (EEPROM), a read-only memory (ROM), a random-access memory (RAM), or the like. The storage unit 190 stores, for example, determination condition information 192, various kinds of information in the embodiment, programs, and the like. The determination condition information 192 includes, for example, information related to conditions for determining one route candidate (travel direction candidate) as a route (travel direction) when there are a plurality of route candidates (travel direction candidates) in a traveling direction of the vehicle M. In addition, the storage unit 190 may store map information (for example, the first map information 54 and the second map information 62).

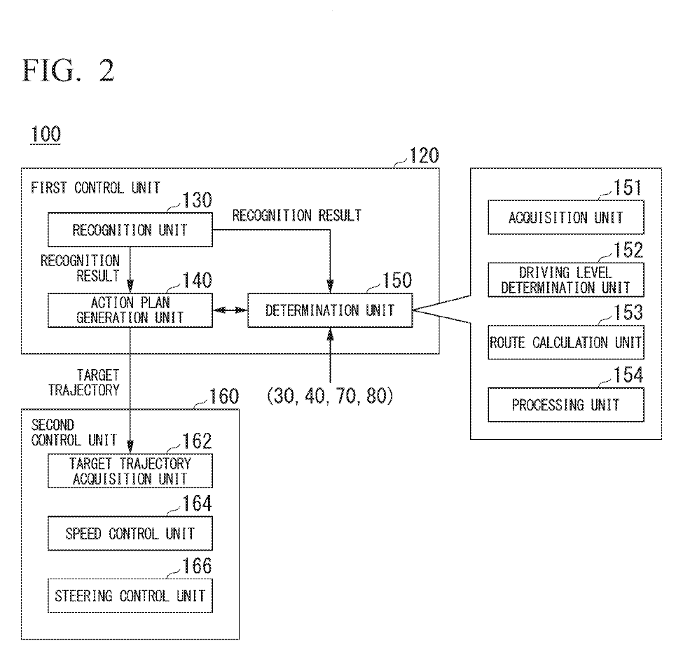

FIG. 2 is a functional configuration diagram of the first control unit 120 and the second control unit 160 according to the embodiment. The first control unit 120 includes, for example, a recognition unit 130, an action plan generation unit 140, and a determination unit 150. The first control unit 120 realizes, for example, functions based on Artificial Intelligence (AI) and functions based on a model given in advance in parallel.

For example, a function of “recognizing an intersection” may be realized by executing, in parallel, recognition of an intersection by deep learning or the like and recognition based on conditions given in advance (for example, presence of signals or road markings capable of pattern matching), and comprehensively evaluating both by assigning scores to both.

The recognition unit 130 recognizes a surrounding situation of the vehicle M on the basis of information input from the detection device DD. For example, the recognition unit 130 recognizes states such as a position (a position relative to the vehicle M), a speed (a speed relative to the vehicle M), and an acceleration of an object (for example, another vehicle or a pedestrian) near the vehicle M (within a predetermined distance from the vehicle M). The position of the object, for example, is recognized as a position on absolute coordinates having a representative point of the vehicle M (a center of gravity, a drive shaft center, or the like) as the origin, and is used for control. The position of the object may be expressed by a representative point such as the center of gravity or a corner of the object, or may be expressed by an area. The “state” of the object may include acceleration or jerk of the object, or “a behavioral state” (for example, whether lane change is performed or to be performed). In addition, the recognition unit 130 may also recognize stop lines, obstacles, red lights, tollhouses, and other road events.

In addition, the recognition unit 130 recognizes, for example, a lane (a traveling lane) in which the vehicle M is traveling. For example, the recognition unit 130 recognizes right and left lane markings of the vehicle M (when seen from the vehicle M) from an image captured by the camera 10 (hereinafter referred to as a camera image) and recognizes the traveling lane on the basis of positions of the recognized lane markings. For example, the recognition unit 130 analyzes the camera image, extracts edge points of which a difference in luminance from neighboring pixels in the image is large, and recognizes a lane marking in an image plane by connecting the edge points. Further, the recognition unit 130 converts positions of lane markings based on a position of a representative point of the vehicle M into a vehicle coordinate system, and recognizes a lane defined by left and right lane markings closest to the vehicle M as a traveling lane. Note that, the recognition unit 130 may recognize an adjacent lane adjacent to the traveling lane based on the recognized lane markings. Further, the recognition unit 130 is not limited to lane markings, and may recognize a traveling lane by recognizing, from an analysis result of a camera image, objects capable of specifying a lane position, including road shoulders, curbstones, medians, guardrails, fences, walls, and the like (travel path boundaries and road boundaries).

Further, the recognition unit 130 may recognize lanes around the vehicle M including a traveling lane on which the vehicle M travels by referring to map information (for example, the second map information 62) based on a position of the vehicle M detected by the vehicle sensors 40 or the GNSS receiver 51. Further, the recognition unit 130 may recognize lane markings that define the traveling lane, and may recognize adjacent lanes adjacent to the traveling lane or lane markings that define the adjacent lanes. Further, the recognition unit 130 may recognize a center line (lane center line) of a traveling lane or an adjacent lane from the map information. Further, the recognition unit 130 may recognize lanes or lane markings around the vehicle M by combining information on lanes or lane markings acquired from a camera image with information on lanes or lane markings acquired from the map information.

Further, when recognizing the traveling lane, the recognition unit 130 may recognize a position and a posture of the vehicle M with respect to the traveling lane. The recognition unit 130 may recognize, for example, a deviation of the reference point of the vehicle M from the lane center and an angle of the traveling direction of the vehicle M relative to a line connecting the lane centers as the relative position and posture of the vehicle M with respect to the traveling lane. Instead, the recognition unit 130 may recognize a position of a reference point of the vehicle M with respect to one side line of the traveling lane (a lane marking or a road boundary) or the like as the relative position of the vehicle M with respect to the traveling lane.

Further, the recognition unit 130 may recognize a road shape in a traveling direction of the vehicle M (for example, a straight road, a curved road, an intersection, and the like), or whether a road shape having a plurality of route candidates within a predetermined distance in the traveling direction exists. Further, the recognition unit 130 may recognize road types around the vehicle M by referring to the map information. The road types include, for example, expressways, connection roads of expressways, primary arterial roads, secondary arterial roads, tertiary arterial roads, residential roads, and other general roads.

In principle, the action plan generation unit 140 generates a target trajectory in which the vehicle M will automatically travel (without depending on an operation of the driver) in the future such that the vehicle M travels in a recommended lane determined by the recommended lane determination unit 61 and can also cope with surrounding situations of the vehicle M. For example, a target trajectory includes a speed factor. For example, the target trajectory is represented as a sequence of points (trajectory points) that the vehicle M should reach. The trajectory point is a point that the vehicle M should reach for a predetermined traveling distance (for example, a few meters) in terms of road distance, and in addition, the target speed and target acceleration are generated as part of the target trajectory for each predetermined sampling time (for example, a few tenths of a second). In addition, the trajectory point may be the position that the vehicle M should reach at each predetermined sampling time. In this case, information on the target speed and target acceleration is expressed as an interval between trajectory points.

The action plan generation unit 140 may set events (functions) of automated driving in generating a target trajectory. The events of automated driving include a constant-speed travel event, a low-speed following travel event, a lane change event, a branching event, a merging event, and an overtaking event. The action plan generation unit 140 generates a target trajectory according to a triggered event. Further, the action plan generation unit 140 generates a target trajectory such that driving control corresponding to contents determined by the driving level determination unit 152 can be executed.

A determination unit 150 includes, for example, an acquisition unit 151, a driving level determination unit 152, a route calculation unit 153, and a processing unit 154. The action plan generation unit 140, the processing unit 154, and the second control unit 160 are examples of a “travel control unit”.

The acquisition unit 151 acquires recognition results recognized by the recognition unit 130, detection results of the vehicle sensors 40, and the like. Further, the acquisition unit 151 acquires, for example, contents of operations of an occupant of the vehicle M from the HMI 30 or the driving operator 80. The operation contents include, for example, information related to control of the vehicle M such as a driving level switching operation described later or route determination conditions during traveling. Further, the operation contents may be information related to a destination input via the navigation device 50. In this case, the acquisition unit 151 may acquire information on whether a destination has been input by the occupant, and when a destination has been input, may acquire information on a specific location of the destination. Further, the acquisition unit 151 may acquire an image obtained by capturing the occupant from the driver monitoring camera 70.

The driving level determination unit 152 determines a driving level of the vehicle M as one of a plurality of driving levels in which tasks imposed on a driver are different (in other words, a plurality of levels having different degrees of automation), based on information acquired by the acquisition unit 151 and the like.

The driving levels of the vehicle M include, for example, a plurality of levels including a first driving level and a second driving level. The first driving level has a higher control state of the vehicle M than the second driving level, that is, a higher degree of automation (degree of control) of driving control of the vehicle M. In other words, the first driving level imposes lighter tasks on an occupant (driver) than the second driving level. The first driving level includes automated driving, and the second driving level may include manual driving. In a case where the first driving level is control related to automated driving and switching is performed from the first driving level to the second driving level, the automated driving control device 100 is responsible for ending control related to automated driving and shifting to manual driving.

Here, the first driving level and the second driving level will be described in detail. In the first driving level, an occupant may not be required to perform either monitoring of surroundings of the vehicle M or gripping of a steering wheel (hereinafter referred to as “steering gripping”). Further, in the first driving level, there may be a restriction in which an occupant is required to perform a task of monitoring surroundings of the vehicle M (hereinafter, surrounding monitoring), but is not required to perform a task of steering gripping. For example, in the first driving level, without accepting a lane change instruction from an occupant (without accepting a driving operation by the occupant), lane change (ALC) of the vehicle M, right/left turn control, lane keeping control (LKAS), and the like based on route setting to a destination by the navigation device 50 may be performed according to a determination on a vehicle system 1 side.

Further, in the first driving level, even in a case where a destination is not set, automated driving in which the vehicle travels along a calculated route based on predetermined route determination conditions in a road-following manner may be performed.

In the second driving level, tasks of surrounding monitoring and steering gripping are imposed on an occupant. The second driving level may be a level in which driving operation by the occupant is required to some extent with respect to at least one of steering and acceleration/deceleration of the vehicle M. Further, the second driving level may be a state of manual driving (manual driving state) in which driving operation by the occupant is required for both steering and acceleration/deceleration of the vehicle M. Further, the driving levels may be three or more driving levels obtained by further subdividing, for each condition, the first driving level or the second driving level.

In a case where a task related to a determined driving level is not executed by a driver, the driving level determination unit 152 changes the driving level to a driving level in which tasks are heavier. For example, during execution of the first driving level, in a case where an occupant is in a posture in which a transition to manual driving cannot be performed in response to a request from a system (for example, in a case where looking away outside an allowable area is continuously performed or in a case where a sign that driving will become difficult is detected), the driving level determination unit 152 causes the HMI control unit 180 to execute control for prompting the occupant to transition to manual driving, which is the second driving level, using the HMI 30. Further, in a case where an occupant does not respond even after a predetermined time has elapsed since the HMI control unit 180 has executed control for prompting a transition to manual driving, or in a case where it is estimated that the occupant is not in a state of performing manual driving, the driving level determination unit 152 performs control such as gradually decelerating the vehicle M while moving the vehicle M toward a target position (for example, a road shoulder) and stopping automated driving. Further, after automated driving is stopped, the vehicle M is in a state of the second driving level, and the vehicle M can be started by a manual operation by the occupant.

The route calculation unit 153 determines a route of the vehicle M according to a state of the vehicle M based on information acquired by the acquisition unit 151 and information determined by the driving level determination unit 152. For example, the route calculation unit 153 determines a travel mode according to the state of the vehicle M in a case where a driving level determined by the driving level determination unit 152 is the first driving level. Details of functions of the route calculation unit 153 will be described later.

The processing unit 154 executes various kinds of processing based on a driving level determined by the driving level determination unit 152 and a route calculated by the route calculation unit 153. For example, the processing unit 154 performs various kinds of processing for changing to the driving level determined by the driving level determination unit 152 or for maintaining a current driving level. For example, the processing unit 154 causes the action plan generation unit 140 to generate a target trajectory for causing the vehicle M to travel, and causes the HMI 30 to output, via the HMI control unit 180, information for prompting an occupant to execute tasks according to a driving level and information related to a route calculated by the route calculation unit 153 (for example, information related to a route determined by a second mode described later). By outputting various kinds of information related to processing executed in the embodiment from the HMI 30, it is possible to suppress giving a sense of discomfort to an occupant due to driving control. Further, even in a situation where a destination is not set, it is possible to notify a future travel direction determined by the route calculation unit 153.

The action plan generation unit 140 generates a target trajectory for causing the vehicle M to travel based on information determined by the determination unit 150, recognition results of the recognition unit 130, and the like.

The second control unit 160 controls the travel driving force output device 200, the brake device 210, and the steering device 220 so that the vehicle M passes through the target trajectory generated by the action plan generation unit 140 at the scheduled time.

The second control unit 160 includes, for example, a target trajectory acquisition unit 162, a speed control unit 164, and a steering control unit 166. The target trajectory acquisition unit 162 acquires information on a target trajectory (trajectory points) generated by the action plan generation unit 140 and stores the information in a memory (not shown). The speed control unit 164 controls the travel driving force output device 200 or the brake device 210 based on speed elements associated with the target trajectory stored in the memory. The steering control unit 166 controls the steering device 220 in accordance with a degree of curvature of the target trajectory stored in the memory. Processing of the speed control unit 164 and the steering control unit 166 is realized, for example, by a combination of feedforward control and feedback control. For example, the steering control unit 166 performs control in combination of feed-forward control based on a curvature of a road in front of the vehicle M and feedback control based on a separation from the target trajectory.

As described above, the action plan generation unit 140, the processing unit 154, and the second control unit 160 perform travel control of the vehicle M along a route (for example, a first route or a second route described later) calculated by the route calculation unit 153.

Referring back to FIG. 1, the HMI control unit 180 uses the HMI 30 to notify the occupant of predetermined information. The predetermined information includes, for example, information on the traveling of the vehicle M, such as information on the state of the vehicle M and information on driving control. For example, the information related to the state of the vehicle M includes a speed of the vehicle M, a rotation frequency of the engine, a shift position, and the like. The information related to driving control includes, for example, an inquiry as to whether to perform a lane change, presence or absence of execution of a driving level, information related to a change of a driving level, information imposed on an occupant required for switching a driving level (task request information to an occupant), and information related to a state of driving control (for example, contents of an executing driving level). Further, the information related to driving control may include information related to a route calculated by the route calculation unit 153 and information related to a route (road) selected by an executing determination mode. Further, the predetermined information may include information not related to driving control of the vehicle M, such as contents stored in a storage medium such as a television program or a DVD (for example, a movie). Further, the predetermined information may include, for example, information related to a current position of the vehicle M, a destination, and a remaining amount of fuel.

For example, the HMI control unit 180 may generate an image including the aforementioned predetermined information and display the generated image on a display device of the HMI 30, or may generate vocal sound indicating the predetermined information and output the generated vocal sound from a speaker of the HMI 30. In addition, the HMI control unit 180 may output information received by the HMI 30 to the communication device 20, the navigation device 50, the first control unit 120, and the like.

The travel driving force output device 200 outputs a traveling driving force (torque) to the driving wheels so that the vehicle travels. The travel driving force output device 200 includes, for example, a combination of an internal combustion engine, an electric motor, a transmission, and an electronic control unit (ECU) that controls these. The ECU controls the above configuration according to the information input from the second control unit 160 or the information input from the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor according to the information input from the second control unit 160 or the information input from the driving operator 80 so that the brake torque corresponding to the braking operation is output to each wheel. The brake device 210 may include a backup mechanism that transmits hydraulic pressure generated by operating a brake pedal included in the driving operator 80 to a cylinder via a master cylinder. Further, the brake device 210 is not limited to the configuration described above, but may be an electronically controlled hydraulic brake device that controls the actuator according to information input from the second control unit 160 and transmits the hydraulic pressure of the master cylinder to the cylinder.

The steering device 220, for example, includes a steering ECU and an electric motor.

The electric motor, for example, applies a force to a rack and pinion mechanism to change the direction of the steered wheels. The steering ECU drives the electric motor and changes the direction of the steered wheels according to the information input from the second control unit 160 or the information input from the driving operator 80.

### Route Calculation Unit

Next, details of functions of the route calculation unit 153 will be described. In the following description, functions of the route calculation unit 153 mainly during execution of a first driving level (automated driving) will be described. In order to calculate a route of the vehicle M based on surrounding situations such as a road shape in a traveling direction of the vehicle M recognized by the recognition unit 130, and instructions from an occupant of the vehicle M acquired by the acquisition unit 151, the route calculation unit 153 calculates the route of the vehicle M using any one of a plurality of calculation modes set in advance.

Here, the plurality of calculation modes include, for example, a first mode and a second mode. The first mode is a mode in which, in a case where a destination of the vehicle M is set, a route is calculated such that the vehicle M travels toward the destination. The second mode is a mode in which, in a case where a destination of the vehicle M is not set, based on predetermined conditions, a route corresponding to a predetermined distance (for example, about 10 km) in terms of road distance is calculated from a current position of the vehicle M. Hereinafter, a route calculated in the first mode may be referred to as a first route, and a route calculated in the second mode may be referred to as a second route. The route calculation unit 153 is capable of calculating, in calculating a route along which the vehicle M travels, a first route calculated in a case where a destination is set, and a second route calculated in a case where a destination is not set.

Here, in calculating the first route or the second route, there may exist, in a traveling direction of the vehicle M, a point having a plurality of route candidates. A point having a plurality of route candidates is, for example, a point at which an intersecting road in which a plurality of lanes including a traveling lane intersect exists, and is, for example, a point at which routes other than straight-ahead routes (for example, routes requiring a right or left turn) such as intersections including a crossroads, a T- shaped intersection, or a Y-shaped intersection exist. Further, a point having a plurality of route candidates may include a roundabout. Hereinafter, a route selection method at a point having a plurality of route candidates will be described for each of a first mode and a second mode.

### First Mode

First, a route selection method in the first mode, that is, a calculation method of the first route, will be described. In calculation of the first route, for each point having a plurality of route candidates, a route directed toward a destination among the plurality of route candidates is selected as a route of the vehicle M.

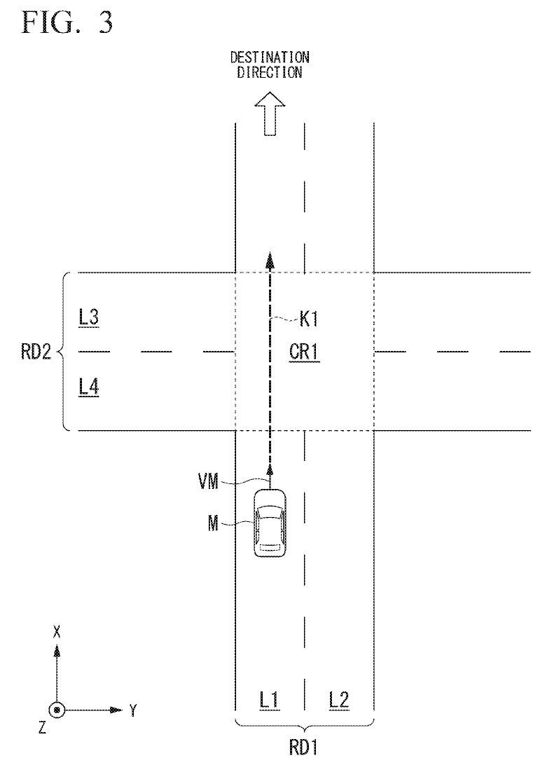

FIG. 3 is a diagram illustrating an example of calculation of a first route and generation of a target trajectory. In the example of FIG. 3, an intersecting road (more specifically, a crossroads) in which a road RD1 and a road RD2 intersect at an intersection CR1 is illustrated. The intersection CR1 is an example of a point having a plurality of route candidates. On the road RD1, there exist a lane L1 on which traveling is possible along an X-axis direction in the drawing and a lane L2 which is an oncoming lane of the lane L1, and on the road RD2, there exist a lane L3 on which traveling is possible along a Y-axis direction in the drawing and a lane L4 which is an oncoming lane of the lane L3. Further, in FIG. 3, it is assumed that the vehicle M is traveling on the lane L1 toward the intersection CR1 at a speed VM (that is, a point having a plurality of route candidates exists within a predetermined distance in the traveling direction of the vehicle M). Further, in the example of FIG. 3, it is assumed that driving control of the vehicle M is executed at the first driving level.

In the example of FIG. 3, in a case where a destination has already been set by an occupant of the vehicle M, the route calculation unit 153 calculates a first route such that the vehicle proceeds toward the destination at an intersection CR1. In the example of FIG. 3, a first route is determined such that the vehicle proceeds straight through the intersection CR1 toward the destination (that is, continues traveling on the lane L1). Then, the action plan generation unit 140 generates a target trajectory K1 such that the vehicle M travels according to the determined first route.

### Second Mode (Principle Processing)

Next, a route selection method in the second mode, that is, a calculation method of a second route, will be described. In the following description, a principle calculation method of the second route will be described. In calculation of the second route, for each point having a plurality of route candidates, as a principle, a route determined based on a predetermined priority order among the plurality of route candidates is selected as a route of the vehicle M. Hereinafter, a road determined based on the predetermined priority order is referred to as a “first road”. The route calculation unit 153 calculates, for each point having a plurality of route candidates, as a principle, the second route such that the vehicle M proceeds to the first road. An exception in which the route calculation unit 153 calculates the second route such that the vehicle M proceeds to a road (a second road) having a lower priority order than the first road will be described later.

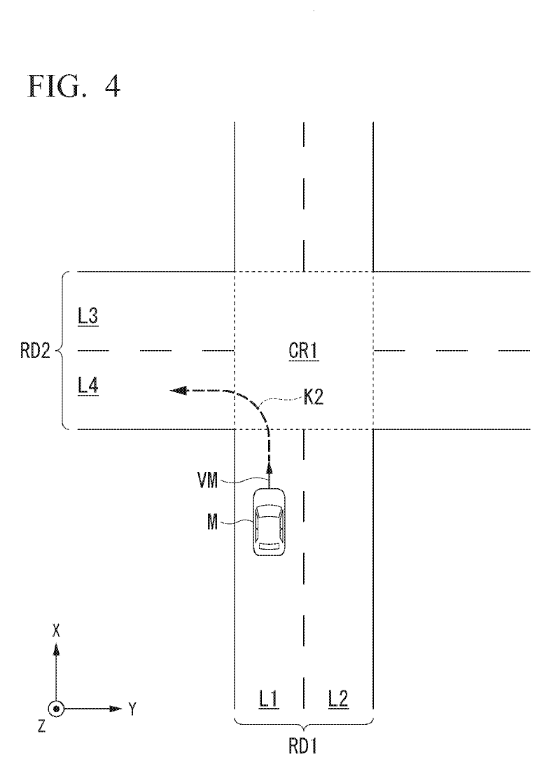

FIG. 4 is a diagram illustrating an example of calculation of a second route and generation of a target trajectory. In the example of FIG. 4, the vehicle M is traveling on an intersecting road similar to that shown in FIG. 3. In a case where a destination of the vehicle M is not set, the route calculation unit 153, as a principle, determines a road on which the vehicle M travels beyond an intersection CR1 based on a predetermined priority order.

The priority order is determined, for example, based on determination condition information 192 stored in the storage unit 190. The determination condition information 192 may include, for example, information relating to road width. The information relating to road width can be acquired, for example, from map information (the first map information 54 and the second map information 62). Further, the determination condition information 192 may include, for example, first information 192A relating to priority based on road standards, and second information 192B relating to road ranks based on comparison between a road on which the vehicle M travels when entering a point (hereinafter referred to as an “approach road”) and an intersecting road. That is, the priority order referenced by the route calculation unit 153 may be based on road width, may be based on priority according to road standards (the first information 192A), may be based on road ranks, or may be based on other criteria.

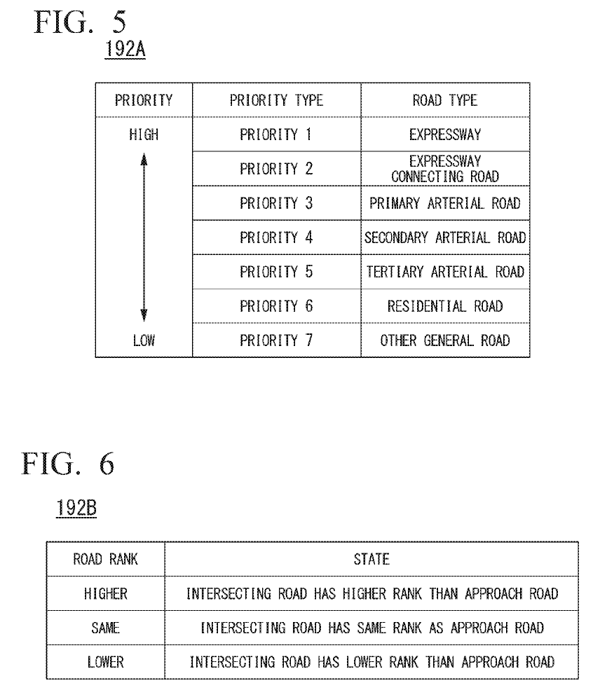

FIG. 5 is a diagram illustrating an example of the first information 192A. In the first information 192A illustrated in FIG. 5, for example, priorities, priority types, and road types are associated with each other. The road type is information relating to road standards and is information that can be acquired, for example, from map information (the first map information 54 and the second map information 62). In the example of FIG. 5, priorities 1 to 7 are assigned in descending order of priority, where “expressway” corresponds to a road type of priority 1, “expressway connecting road” corresponds to a road type of priority 2, “primary arterial road” corresponds to a road type of priority 3, “secondary arterial road” corresponds to a road type of priority 4, “tertiary arterial road” corresponds to a road type of priority 5, “residential road” corresponds to a road type of priority 6, and “other general road” corresponds to a road type of priority 7. Note that the number of priorities and road types assigned to each priority in the embodiment are not limited to the example illustrated in FIG. 5. Further, the determination condition information 192 does not necessarily include the first information 192A.

FIG. 6 is a diagram illustrating an example of the second information 192B. In the second information 192B illustrated in FIG. 6, for example, road ranks are associated with states of a traveling lane and an intersecting road. For example, a rank of “higher” indicates that the intersecting road has a higher rank than the approach road, a rank of “same” indicates that the intersecting road has the same rank as the approach road, and a rank of “lower” indicates that the intersecting road has a lower rank than the approach road. The road rank may be determined, for example, according to priorities included in the first information 192A. For example, in a case where a priority type of a road including the traveling lane (for example, the road RD1) is “priority 4,” if a priority type of an intersecting road (for example, the road RD2) is “priority 3,” “priority 2,” or “priority 1,” the road rank of the intersecting road is “higher”. If the priority type is “priority 4,” the road rank of the intersecting road is “same”. If the priority type is “priority 5,” “priority 6,” or “priority 7,” the road rank of the intersecting road is “lower”. Note that the road rank may be set based on other criteria. Further, the determination condition information 192 does not necessarily include the second information 192B.

In a case of calculating the second route, the route calculation unit 153 determines the route of the vehicle M when passing through the intersection CR1 using a priority order based on at least one of the following: information about the road width, the first information 192A, and the second information 192B. For example, the route calculation unit 153 acquires road widths of roads RD1 and RD2 connected to the intersection CR1 based on position information of the vehicle M, and determines a route of the vehicle M at passage through the intersection CR1 based on the acquired road widths. Alternatively, the route calculation unit 153 may acquire road types of the roads RD1 and RD2 based on the position information of the vehicle M, and may acquire priorities associated with the acquired road types. Then, the route calculation unit 153 may determine a route of the vehicle M based on the acquired priorities. Further, the route calculation unit 153 may acquire road ranks corresponding to priority types of a road including a traveling lane and an intersecting road using the second information 192B, and may determine a route of the vehicle M based on the acquired road ranks.

For example, the route calculation unit 153 determines a route such that the vehicle M travels on a road having the widest road width. In a case where a plurality of lanes are included in the road RD2, the route calculation unit 153 selects a lane in a predetermined direction as viewed from the vehicle M. Further, the route calculation unit 153 may determine, as a route of the vehicle M, a lane that does not pass through another lanes (for example, an oncoming lane). Accordingly, the vehicle M can be moved in a direction with less risk and higher safety.

In the example of FIG. 4, the road RD2 has a wider road width than the road RD1. Therefore, the route calculation unit 153 determines a route of the vehicle M to be the road RD2. That is, in the example of FIG. 4, the road RD2 is a first road, and a second route is calculated such that the vehicle M proceeds to the road RD2 that is the first road. Further, among lanes L3 and L4 included in the road RD2, since the lane L3 is an oncoming lane, the route calculation unit 153 determines the lane L4 as a route. The action plan generation unit 140 generates a target trajectory K2 for turning left at the intersection CR1 and traveling on the lane L4, outputs the generated target trajectory K2 to the second control unit 160, and causes the generated target trajectory K2 to execute driving control.

Alternatively, the route calculation unit 153 may determine a route such that the vehicle M travels on a road having a higher priority. For example, in a case where a priority type of a traveling lane is “priority 4,” a priority type corresponding to a road rank “higher” of an intersecting road is “priority 1,” “priority 2,” or “priority 3,” a priority type corresponding to a road rank “same” is “priority 4,” and a priority type corresponding to a road rank “lower” is “priority 5,” “priority 6,” or “priority 7”. For example, in a case where a lane of the road RD2 (a lane other than a traveling lane) is lower than or equal to the traveling lane L1, the route calculation unit 153 determines the current lane L1 as a route, and in a case where a lane of the road RD2 is higher, determines a lane included in the road RD2 as a route.

In the example of FIG. 4, a road rank of the road RD2 is higher than that of the road RD1. Therefore, the route calculation unit 153 determines a route of the vehicle M to be the road RD2, and further, among lanes L3 and L4 included in the road RD2, since the lane L3 is an oncoming lane, determines the lane L4 as a route.

By calculating the second route as described above, in a case where a road shape in which an intersecting road or the like exists is included in the second route, even in a case where a destination is not set, driving control at a first driving level can be continued. Further, since a route is determined based on a priority order set in advance with respect to a road width, a road standard, or the like, determination conditions become clear, thereby reducing a sense of discomfort of an occupant, and since following-the-road travel can be continued, candidates of destinations can be expanded.

Note that, in a case where a first road determined based on a priority order based on road width and a first road determined based on a priority order based on road standards (priority and road rank) are different roads, the route calculation unit 153 may determine the first road based on either one (for example, road width) of the priority orders. Alternatively, the route calculation unit 153 may determine the first road by performing comprehensive evaluation, for example, assigning scores to each of these priority orders.

Further, in calculating of the second route, in a case where a road width of a road extending straight ahead from an approach road (that is, a road continuing from the approach road; hereinafter referred to as a straight-ahead road) is equal to or greater than a predetermined value, the route calculation unit 153 may select the straight-ahead road as a route even in a case where an intersecting road has a wider road width than the straight-ahead road.. Similarly, in a case where a priority of the straight-ahead road is equal to or greater than a predetermined value, the route calculation unit 153 may select the straight-ahead road as a route even in a case where a priority of an intersecting road is higher than the priority of the straight-ahead road. Accordingly, it is possible to suppress a state in which right and left turns occur whenever an intersecting road exists. Therefore, it is possible to reduce a sense of discomfort of an occupant of the vehicle M, and to suppress a situation in which the vehicle M travels on an unintended higher-ranked road (such as an expressway) unintended by the occupant.

Further, in a case where the route calculation unit 153 calculates the second route, the route calculation unit 153 may determine a route based on a priority order related to a road shape. Hereinafter, route determination methods will be described by giving several examples of road shapes.

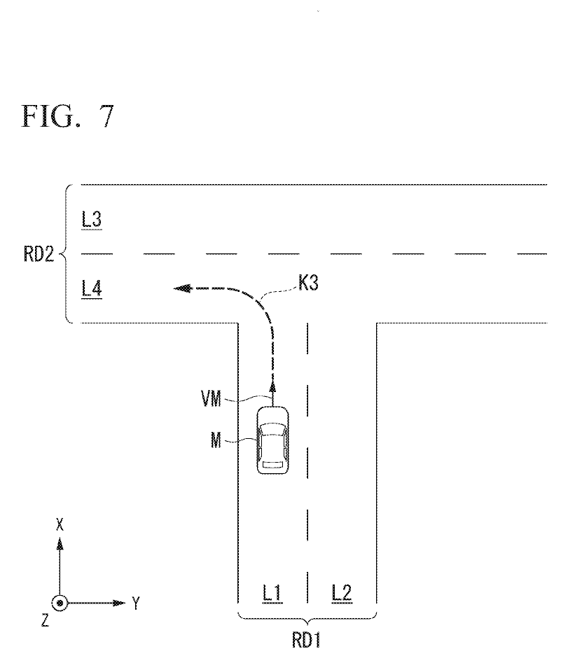

FIG. 7 is a diagram illustrating an example of a road shaped of a T-shaped intersection. In the example of FIG. 7, the road RD1 is connected to the road RD2, and the road RD1 has a shape in which it is not possible to go straight at the connection portion (that is, a shape in which the vehicle M traveling toward the T-shaped intersection on the lane L1 necessarily needs to make a right or left turn). In a case where a point having a plurality of route candidates in a traveling direction of the vehicle M is a T-shaped intersection, when the vehicle M reaches the connection point, a right turn or a left turn is required regardless of road widths or road ranks of the roads RD1 and RD2. Accordingly, when traveling through a T-shaped intersection, the route calculation unit 153 determines either a right-turn route or a left-turn route as having the highest priority order regardless of road widths, road ranks, or priorities, and determines either the right-turn route or the left-turn route as the second route. In the example of FIG. 7, the lane L4 that is not an oncoming lane is determined as the second route, and a target trajectory K3 for causing the vehicle M to turn left is generated.

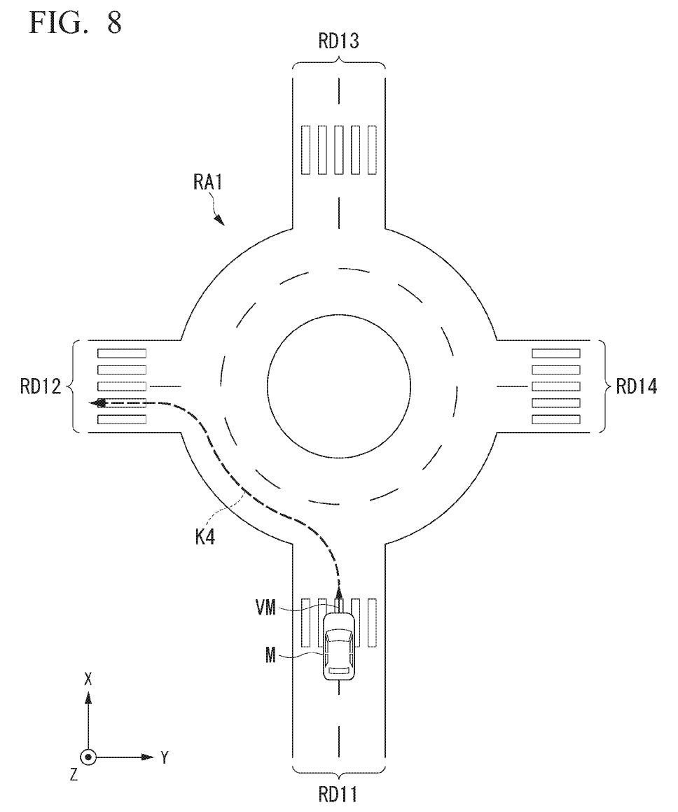

FIG. 8 is a diagram illustrating an example of a road shape of a roundabout. A roundabout RA1 illustrated in FIG. 8 includes four roads RD11 to RD14 connected to a circular road portion. The vehicle M is assumed to be traveling toward the roundabout RA1 on the road RD11 at a speed VM. In a case where the roundabout RA1 exists in a traveling direction, the route calculation unit 153 determines that a road RD12, which is a first exit immediately after entering a circular road portion, has the highest priority order regardless of road widths, road ranks, or priorities, and determines the road RD12 as a second route. The action plan generation unit 140 generates a target trajectory K4 for traveling on the determined route, that is, the road RD12.

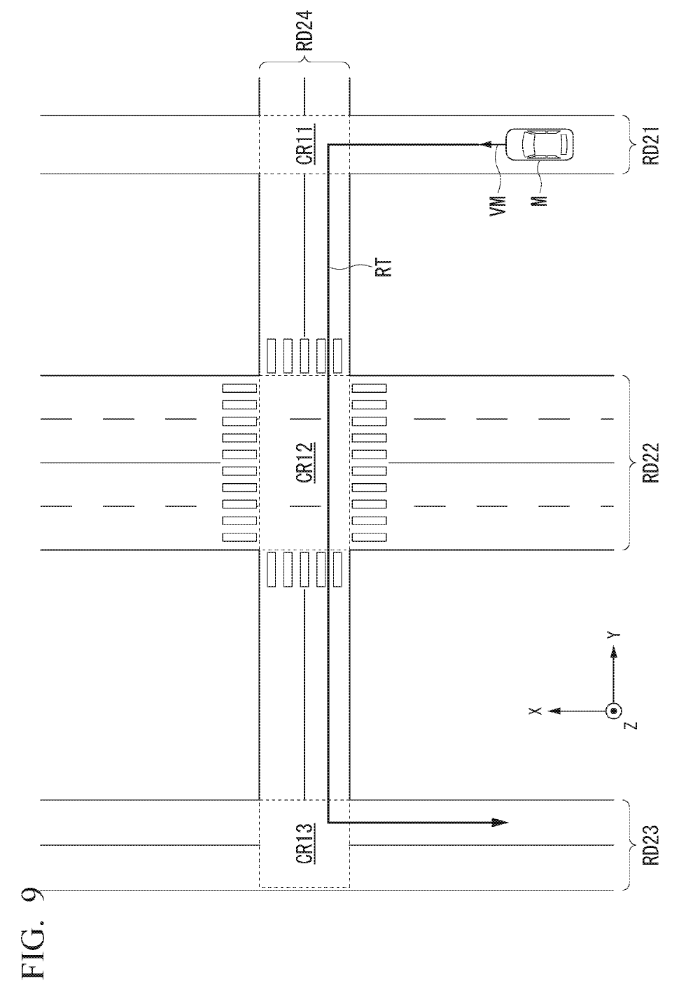

Next, an example of following-the-road travel in a situation where a destination is not set (that is, there is no navigation route) will be described. FIG. 9 is a diagram illustrating an example of following-the-road travel in a situation where a destination is not set. The example of FIG. 9 illustrates a scene in which automated driving is performed on a second route (route RT) determined by the route calculation unit 153 in a situation in which a destination is not set. In the example of FIG. 9, three roads RD21, RD22, and RD23 extending in an X-axis direction in the drawing and a road RD24 extending in a Y-axis direction in the drawing and connected to each of the roads RD21, RD22, and RD23 are illustrated. The road RD21 and the road RD24 are connected at an intersection CR11, the road RD22 and the road RD24 are connected at an intersection CR12, and the road RD23 and the road RD24 are connected at an intersection CR13. In addition, the vehicle M is assumed to be traveling toward the intersection CR11 on the road RD21 at a speed VM.

The route calculation unit 153 searches for a point having a plurality of route candidates in the traveling direction of the vehicle M, and detects the intersection CR11 as such a point. Note that the search may be performed based on map information. At the intersection CR11, the route calculation unit 153 compares priority orders of the road RD21 and the road RD24, and, since the road RD24 has a higher priority order, sets (extends) the second route to pass through the road RD24. Next, the route calculation unit 153 searches for a point having a plurality of route candidates in the traveling direction of the vehicle M, and detects the intersection CR12 as such a point. At the intersection CR12, the route calculation unit 153 compares priority orders of the road RD22 and the road RD24. Here, although the road RD22 is a road having a higher priority order than the road RD24, since a road width of the road RD24 is equal to or greater than a predetermined value, the route calculation unit 153 sets (extends) the second route to pass through a straight-ahead road (that is, the road RD24). Next, the route calculation unit 153 searches for a point having a plurality of route candidates in the traveling direction of the vehicle M, and detects the intersection CR13 as such a point. Since the intersection CR13 is a T-shaped intersection, the route calculation unit 153 determines a left-turn route as having the highest priority order, and sets (extends) the second route to turn left at the intersection CR13 and proceed on the road RD23.

The route calculation unit 153 repeats such setting (extension) of the second route until a length of the second route reaches a predetermined length. The action plan generation unit 140 generates a target trajectory along the second route (route RT) generated in this manner. Accordingly, travel control of the vehicle M along the second route (route RT) is performed.

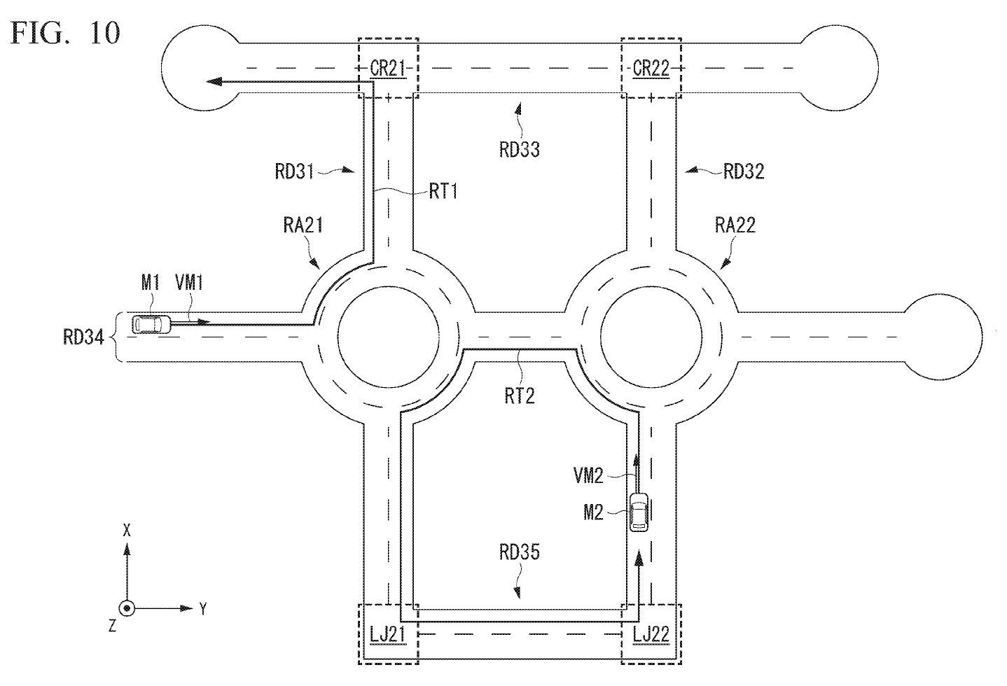

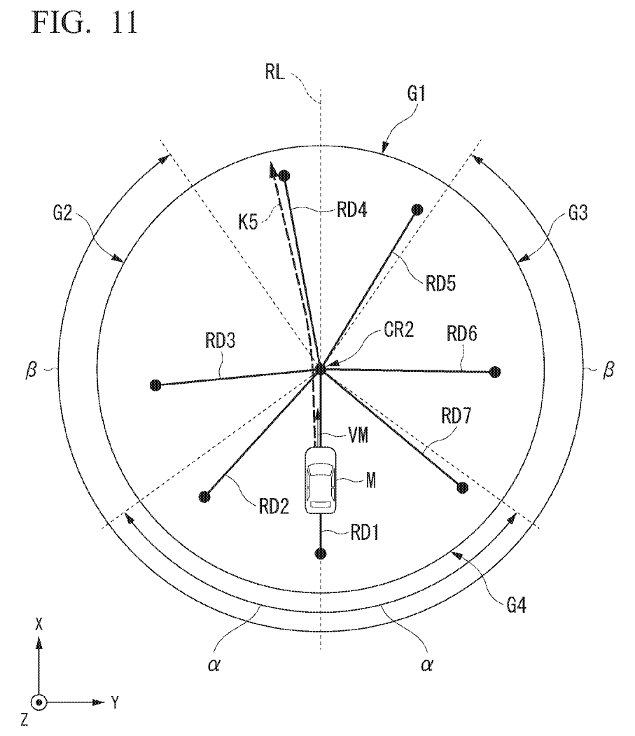

FIG. 10 is a diagram illustrating an example of following-the-road travel in a situation where a destination is not set. The example of FIG. 10 illustrates a scene in which automated driving is performed on second routes (routes RT1 and RT2) determined by the route calculation unit 153 in a situation in which a destination is not set. In the example of FIG. 10, two roads RD31 and RD32 extending in an X-axis direction in the drawing and three roads RD33, RD34, and RD35 extending in a Y-axis direction in the drawing are illustrated. The road RD31 and the road RD33 are connected at an intersection CR21, the road RD31 and the road RD34 are connected at a roundabout RA21, and the road RD31 and the road RD35 are connected at an L-shaped intersection LJ21. Further, the road RD32 and the road RD33 are connected at an intersection CR22, the road RD32 and the road RD34 are connected at a roundabout RA22, and the road RD32 and the road RD35 are connected at an L-shaped intersection LJ22. Further, a vehicle M1 is assumed to be traveling toward the roundabout RA21 on the road RD34 at a speed VM1, and a vehicle M2 is assumed to be traveling toward the roundabout RA22 on the road RD32 at a speed VM2.

For the vehicle M1, the route calculation unit 153 searches for a point having a plurality of route candidates in a traveling direction of the vehicle M1, and detects the roundabout RA21 as such a point. The route calculation unit 153 determines that a first exit immediately after entering the roundabout RA21 has the highest priority order, and sets (extends) the second route so as to turn left at the roundabout RA21 and proceed on the road RD31. Next, the route calculation unit 153 searches for a point having a plurality of route candidates in the traveling direction of the vehicle M1, and detects the intersection CR21 as such a point. Since the intersection CR21 is a T-shaped intersection, the route calculation unit 153 determines a left-turn route as having the highest priority order, and sets (extends) the second route so as to turn left at the intersection CR21 and proceed on the road RD33.

Here, since a dead end exists ahead along the road RD33, the route calculation unit 153 may set the dead end as a terminal end of the second route and end calculation of the second route. For the vehicle M1, the action plan generation unit 140 generates a target trajectory along the second route (route RT1) generated in this manner. Accordingly, travel control of the vehicle M along the second route (route RT1) is performed. In addition, by calculating a route that causes the vehicle M to stop at the dead end rather than calculating a route that returns to the road from which the vehicle came (for example, a U-turn), safe travel control can be executed.

For the vehicle M2, the route calculation unit 153 searches for a point having a plurality of route candidates in a traveling direction of the vehicle M2, and detects the roundabout RA22 as such a point. The route calculation unit 153 determines that a first exit immediately after entering the roundabout RA22 has the highest priority order, and sets (extends) the second route so as to turn left at the roundabout RA22 and proceed on a road RD34. Next, the route calculation unit 153 searches for a point having a plurality of route candidates in the traveling direction of the vehicle M2, and detects the roundabout RA21 as such a point. The route calculation unit 153 determines that a first exit immediately after entering the roundabout RA21 has the highest priority order, and sets (extends) the second route to turn left at the roundabout RA21 and proceed on a road RD31. Next, the route calculation unit 153 searches for a point having a plurality of route candidates in the traveling direction of the vehicle M2.

Here, the L-shaped intersections LJ21 and LJ22 existing in the traveling direction of the vehicle M2 do not correspond to “points having a plurality of route candidates”. Accordingly, the route calculation unit 153 does not detect these points as points having a plurality of route candidates. As a result, the route calculation unit 153 again detects the roundabout RA22 as a point having a plurality of route candidates. Accordingly, the route calculation unit 153 calculates a second route (route RT2) including a loop shape. For the vehicle M2, the action plan generation unit 140 generates a target trajectory along the second route (route RT2) generated in this manner. Accordingly, travel control of the vehicle M along the second route (route RT2) is performed. Note that, in a case where the second route loops a predetermined number of times or more, the route calculation unit 153 may calculate the second route such that the vehicle M proceeds to a road that has not been selected in the past at a next point having a plurality of route candidates.

As described above, by calculation of the second route by the route calculation unit 153, even in a case where the vehicle travels through a point at which a plurality of route candidates exist in a situation where a destination is not set, an appropriate route can be calculated and appropriate travel control can be executed. Accordingly, it is possible to reduce a sense of discomfort of an occupant, and since following-the-road travel can be continued, destination candidates can be expanded.

### Second Mode (Exceptional Processing)

Next, an exceptional calculation method of the second route will be described. The exceptional calculation method for the second route is applied, for example, when the vehicle M proceeds to a point where multiple route candidates exist and the angle of the first road relative to the approach road is equal to or less than a predetermined angle. In this case, the route calculation unit 153 selects the second road with a lower priority order than the first road. That is, the route calculation unit 153 calculates the second route so that the vehicle M proceeds on the second road.

FIG. 11 is a diagram illustrating an example of a case where a second road having a lower priority order than a first road is selected. In the example of FIG. 11, an intersecting road in which the roads RD1 to RD7 intersect at an intersection CR2 is illustrated. The intersection CR2 is an example of a point having a plurality of route candidates. Further, in FIG. 11, the vehicle M is assumed to be traveling on the road RD1 toward the intersection CR2 at a speed VM. That is, in FIG. 11, the road RD1 is an approach road. The roads RD2 to RD7 are examples of the plurality of route candidates. Further, in the example of FIG. 11, it is assumed that a first road having a high priority order (for example, a road having the widest road width) selected based on the above-described principle calculation method is the road RD2.

The route calculation unit 153 calculates an angle of the road RD2 (the first road) with respect to the road RD1 that is the approach road. The route calculation unit 153 may calculate the angle based on map information (first map information 54 and second map information 62). Then, in a case where the angle of the road RD2 with respect to the road RD1 is equal to or less than a predetermined angle α, the route calculation unit 153 selects a road other than the road RD2, that is, a second road having a lower priority order than the road RD2. The value of the angle α is a preset value, and may be set, for example, so as to correspond to a lower limit value of an angle at which steering control of the vehicle M can be smoothly performed. The value of the angle α may be a lower limit value of a steering angle of the vehicle M by the automated driving control device 100, or may be a value larger than the lower limit value. The angle α may be, for example, about 30°; however, a specific value thereof can be appropriately changed. The second road may be a road having an angle with respect to the road RD1 that is greater than the predetermined angle α.

Accordingly, when automated driving is performed in a state where an occupant has not set a destination, it is possible to suppress a situation in which continuation of automated driving becomes difficult and automated driving is canceled regardless of an intention of the occupant.

That is, in a case where a road having a small intersecting angle exists, it is possible to avoid an event in which the vehicle M must be steered at an angle smaller than a lower limit value of an angle at which smooth steering control by the automated driving control device 100 is possible, and thereby, it is possible to execute smooth travel control.

In the example of FIG. 11, the roads RD3 to RD6 correspond to second roads. That is, a plurality of second roads exist among a plurality of route candidates. In a case where a plurality of second roads exist among the plurality of route candidates, the route calculation unit 153 may select a second road closest to straight travel among the plurality of second roads.

In the example of FIG. 11, a road closest to straight travel from the road RD1 that is an approach road is the road RD4. Therefore, the route calculation unit 153 selects the road RD4. The action plan generation unit 140 generates a target trajectory K5 such that the vehicle M proceeds to the road RD4.

As described above, by setting a condition that, in a case where proceeding to a road having a high priority order (for example, a road having a wide road width) is difficult, a road close to straight travel is selected, it becomes easy for an occupant to understand where the vehicle M will proceed in travel control in which a destination is not set, such as proceeding to a road having a high priority order or proceeding in a straight direction. Accordingly, the occupant can use travel control in which a destination is not set with peace of mind.

Further, the route calculation unit 153 may, for example, based on map information, classify the roads RD1 to RD7 connected to the intersection CR2 other than an approach road (that is, roads RD2 to RD7) into a straight group G1, a left-turn group G2, a right-turn group G3, and a non-target group G4. Here, the straight group G1 is a group of roads each having an angle with respect to the approach road that is greater than a predetermined angle β and equal to or less than 180°. The angle β is a preset value and is a value greater than the angle α. The angle β may be, for example, about 150°.

The left-turn group G2 is a group of roads each having an angle with respect to the approach road that is greater than the angle α and smaller than the angle β, and that are located on a left side with respect to the approach road. The right-turn group G3 is a group of roads each having an angle with respect to the approach road that is greater than the angle α and smaller than the angle β, and that are located on a right side with respect to the approach road. The non-target group G4 is a group of roads that do not belong to any of the straight group G1, the left-turn group G2, and the right-turn group G3. That is, the non-target group G4 is a group of roads each having an angle with respect to the approach road that is smaller than the angle α. The second road may be defined as a road belonging to any one of the straight group G1, the left-turn group G2, and the right-turn group G3. In this case, in a case where the first road belongs to the non-target group G4, the route calculation unit 153 may not select the first road as a route, and may select, as a route, a road belonging to another group (for example, the straight group G1) among the groups G1 to G3, that is, a second road.

Further, the route calculation unit 153 may, at a certain point (hereinafter referred to as a “steering control difficult point”), in a case where no second road exists among a plurality of route candidates, or in a case where it is determined that it is difficult for the vehicle M to proceed to the second road, calculate a different second route at an intersection or a branch point before the vehicle M reaches the steering control difficult point. That is, the route calculation unit 153 may change the second route at an intersection or a branch point before the steering control difficult point such that the steering control difficult point is not included in the second route. Examples of a case where no second road exists include a case in which, for all roads connected to the steering control difficult point, an angle with respect to an approach road is equal to or less than the angle α. Examples of a case where it is difficult for the vehicle M to proceed to the second road include a case in which the vehicle M must cross many lanes in order to proceed to the second road and travel control is difficult. Accordingly, it is possible to suppress occurrence of an event in which the vehicle M reaches a first road having a high priority order but cannot enter the first road.

Note that, in the above description, it has been described that the exceptional calculation method of the second route is applied in a case where an angle of a first road with respect to an approach road is equal to or less than a predetermined angle α; however, instead of this (or in addition thereto), the exceptional calculation method of the second route described above may be applied in a case where a steering control amount becomes equal to or greater than a predetermined value in a case where the vehicle M proceeds to the first road. That is, the route calculation unit 153 may calculate the second route such that the vehicle M proceeds to the second road in a case where the angle of the first road with respect to the approach road is equal to or less than the predetermined angle α, or in a case where the steering control amount becomes equal to or greater than a predetermined value when the vehicle M proceeds to the first road. The steering control amount is, for example, a control amount of the steering device 220 by the second control unit 160 (a steering control unit 166).

### Processing Flow

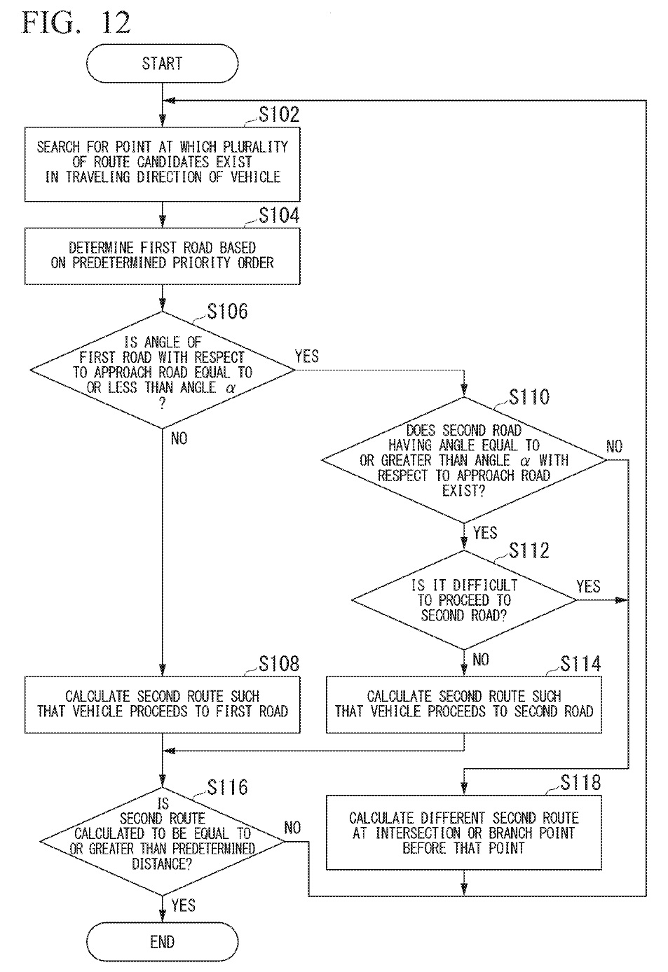

Hereinafter, processing executed by the automated driving control device 100 of the embodiment will be described. FIG. 12 is a flowchart illustrating an example of a flow of processing executed by the automated driving control device 100 (more specifically, the route calculation unit 153). In the following description, among the processing executed by the automated driving control device 100, processing for calculation of the second route will be mainly described. The processing described below may be repeatedly executed at a predetermined timing or at a predetermined cycle during execution of the second mode at the first driving level.

In the example of FIG. 12, the route calculation unit 153 searches, in a traveling direction of the vehicle M, for a point at which a plurality of route candidates exist (step S102). Next, the route calculation unit 153 determines a first road at the searched point based on a predetermined priority order (for example, a priority order regarding road width) (step S104). For example, the route calculation unit 153 may determine, as the first road, a road having the highest priority order at the searched point.

Next, the route calculation unit 153 determines whether an angle of the first road with respect to an approach road is equal to or less than the angle α (step S106). In a case where it is determined that the angle of the first road with respect to the approach road is not equal to or less than the angle α (step S106; NO), the route calculation unit 153 calculates (extends) the second route such that the vehicle M proceeds to the first road (step S108).

In a case where it is determined that the angle of the first road with respect to the approach road is equal to or less than the angle α (step S106; YES), the route calculation unit 153 determines whether a second road having an angle equal to or greater than the angle α with respect to the approach road exists at that point (step S110). In a case where it is determined that the second road having an angle equal to or greater than the angle α with respect to the approach road exists (step S110; YES), the route calculation unit 153 determines whether it is difficult for the vehicle M to proceed to the second road (step S112). In a case where it is determined that it is not difficult for the vehicle M to proceed to the second road (step S112; NO), the route calculation unit 153 calculates (extends) the second route such that the vehicle M proceeds to the second road. Note that, in a case where a plurality of second roads having angles equal to or greater than the angle α with respect to the approach road and not being difficult to proceed to exist, the route calculation unit 153 may select a second road closest to straight travel among the plurality of second roads. Then, it may calculate (extend) the second route such that the vehicle M proceeds to the selected second road.

In a case where it is determined that no second road having an angle equal to or greater than the angle α with respect to the approach road exists (step S110; NO), or in a case where it is determined that it is difficult for the vehicle M to proceed to the second road (step S112; YES), the route calculation unit 153 calculates a different second route at an intersection or a branch point before that point (that is, the steering control difficult point) (step S118). For example, the route calculation unit 153 changes the second route at an intersection or a branch point before the steering control difficult point such that the steering control difficult point is not included in the second route. Thereafter, the route calculation unit 153 repeats processing from step S102 onward based on the changed second route. That is, the route calculation unit 153 again searches, in a traveling direction of the vehicle M based on the changed second route, for a point at which a plurality of route candidates exist, and performs processing from step S104 onward again for the searched point, thereby calculating (extending) the second route again.

After the second route is calculated (extended) by processing of step S108 or step S114, the route calculation unit 153 determines whether the second route has been calculated to be equal to or greater than a predetermined distance (step S116). In a case where it is not determined that the second route has been calculated to be equal to or greater than the predetermined distance (step S116; NO), processing from step S102 onward is repeated. That is, the route calculation unit 153 again searches, in a traveling direction of the vehicle M, for a point at which a plurality of route candidates exist, and performs processing from step S104 onward again for the searched point, thereby calculating (extending) the second route again.

In a case where it is determined that the second route has been calculated to be equal to or greater than the predetermined distance (step S116; YES), the processing of this flowchart ends.

According to the embodiment described above, the automated driving control device 100 (an example of a travel control device) includes the route calculation unit 153 configured to calculate, in calculating a route along which a vehicle M travels, a first route calculated in a case where a destination is set and a second route calculated in a case where a destination is not set, and the travel control unit (the processing unit 154, the action plan generation unit 140, and the second control unit 160) that performs travel control of the vehicle M along the first route or the second route calculated by the route calculation unit 153, in which when the vehicle M proceeds to a point at which a plurality of route candidates exist, the route calculation unit 153 calculates the second route such that the vehicle M proceeds to a first road determined based on a predetermined priority order among the plurality of route candidates, and in a case where an angle of the first road with respect to a road on which the vehicle M travels when entering the point is equal to or less than a predetermined angle α, or in a case where a steering control amount becomes equal to or greater than a predetermined value in a case where the vehicle M proceeds to the first road, calculates the second route such that the vehicle M proceeds to a second road having a lower priority order than the first road. Accordingly, smooth travel control can be executed even in a case where a road having a small intersecting angle exists. Thus, it is possible to contribute to development of a sustainable transportation system.

The embodiment described above can be expressed as below.

A travel control device including
a storage medium storing computer-readable instructions, and
a processor connected to the storage medium, in which
the processor executes the computer-readable instructions to:
calculate, in calculating a route along which a vehicle travels, a first route calculated in a case where a destination is set, or a second route calculated in a case where a destination is not set,
perform travel control of the vehicle along the calculated first route or the calculated second route,
when the vehicle proceeds to a point at which a plurality of route candidates exist,
calculate the second route such that the vehicle proceeds to a first road determined based on a predetermined priority order among the plurality of route candidates, and
in a case where an angle of the first road with respect to a road on which the vehicle travels when the vehicle enters the point is equal to or less than a predetermined angle, or in a case where a steering control amount becomes equal to or greater than a predetermined value in a case where the vehicle proceeds to the first road, calculate the second route such that the vehicle proceeds to a second road having a lower priority order than the first road.

### Modification Examples

In the above-described embodiment, in a case where a plurality of second roads exist, the route calculation unit 153 selects a second road closest to straight travel among the plurality of second roads; however, a method of selecting a second road is not limited thereto and may be appropriately changed. For example, the route calculation unit 153 may select, among the plurality of second roads, a second road having the highest priority order based on the road width, the priority, the road rank, or the like. Alternatively, the route calculation unit 153 may select a second road in consideration of both priority order and degree of straightness (degree of closeness to straight travel). For example, the route calculation unit 153 may select a second road having the highest priority order among second roads belonging to the straight group G1.

Further, the route calculation unit 153 may be configured to calculate a different second route at an intersection or a branch point before the vehicle M reaches the point in a case where an angle of the first road with respect to a road on which the vehicle M travels when proceeding to a point at which a plurality of route candidates exist (an approach road) is equal to or less than a predetermined angle α, or in a case where a steering control amount becomes equal to or greater than a predetermined value in a case where the vehicle M proceeds to the first road. According to this configuration, in a case where it is difficult for the vehicle M to proceed to a road having a high priority order at a certain point, the second route is changed at a time before the vehicle M reaches the point such that the vehicle M does not proceed to the point. Accordingly, it is possible to suppress occurrence of an event in which the vehicle M reaches a point at which a road having a high priority order exists but cannot proceed to the road. While an occupant is unlikely to feel discomfort even if the vehicle proceeds to a road having a lower priority order at an intersection or the like at which a road (for example, a road having a wide road width) having a high priority order does not exist, the occupant may feel discomfort if the vehicle proceeds to a route having a lower priority order at an intersection or the like at which a road having a high priority order exists. Therefore, by suppressing occurrence of such an event, the occupant is less likely to feel discomfort.

As above, although a form for performing the present invention has been described using the embodiment, the present invention is not limited to such an embodiment at all, and various modifications and substitutions can be applied within a range not departing from the concept of the present invention.

What is claimed is:

1. A travel control device comprising:
a storage medium storing computer-readable instructions; and
one or more processors connected to the storage medium, the processor executing the computer-readable instructions to:
calculate, in calculating a route along which a vehicle travels, a first route calculated in a case where a destination is set, or a second route calculated in a case where a destination is not set;
perform travel control of the vehicle along the calculated first route or the calculated second route;
when the vehicle proceeds to a point at which a plurality of route candidates exist, calculate the second route such that the vehicle proceeds to a first road determined based on a predetermined priority order among the plurality of route candidates; and
in a case where an angle of the first road with respect to a road on which the vehicle travels when the vehicle enters the point is equal to or less than a predetermined angle, or in a case where a steering control amount becomes equal to or greater than a predetermined value in a case where the vehicle proceeds to the first road, calculate the second route such that the vehicle proceeds to a second road having a lower priority order than the first road.

2. The travel control device according to claim 1,
wherein the one or more processors execute the computer-readable instructions to:
in a case where a plurality of the second roads exist among the plurality of route candidates, select the second road closest to straight travel among the plurality of second roads.

3. The travel control device according to claim 1,
wherein the one or more processors execute the computer-readable instructions to:
in a case where the second road does not exist among the plurality of route candidates, or in a case where it is determined that it is difficult for the vehicle to proceed to the second road, calculate a different second route at an intersection or a branch point before the vehicle reaches the point.

4. The travel control device according to claim 1, wherein the priority order is based on a road width.

5. A travel control method executed by a computer, the travel control method comprising:
calculating, in calculating a route along which a vehicle travels, a first route calculated in a case where a destination is set, or a second route calculated in a case where a destination is not set;
performing travel control of the vehicle along the calculated first route or the calculated second route;
when the vehicle proceeds to a point at which a plurality of route candidates exist, calculating the second route such that the vehicle proceeds to a first road determined based on a predetermined priority order among the plurality of route candidates; and
in a case where an angle of the first road with respect to a road on which the vehicle travels when the vehicle enters the point is equal to or less than a predetermined angle, or in a case where a steering control amount becomes equal to or greater than a predetermined value in a case where the vehicle proceeds to the first road, calculating the second route such that the vehicle proceeds to a second road having a lower priority order than the first road.

6. A computer-readable non-transitory storage medium storing a program, the program causing a computer to:
calculate, in calculating a route along which a vehicle travels, a first route calculated in a case where a destination is set, or a second route calculated in a case where a destination is not set;
perform travel control of the vehicle along the calculated first route or the calculated second route;
when the vehicle proceeds to a point at which a plurality of route candidates exist, calculate the second route such that the vehicle proceeds to a first road determined based on a predetermined priority order among the plurality of route candidates; and
in a case where an angle of the first road with respect to a road on which the vehicle travels when the vehicle enters the point is equal to or less than a predetermined angle, or in a case where a steering control amount becomes equal to or greater than a predetermined value in a case where the vehicle proceeds to the first road, calculate the second route such that the vehicle proceeds to a second road having a lower priority order than the first road.
